(19) United States
(12) Patent Application Publication
(10) Pub. No.: US 2007/0241680 A1
(43) Pub. Date: Oct. 18, 2007

(54) Photomultiplier

(75) Inventors: Takayuki Ohmura, Hamamatsu-shi (JP); Suenori Kimura, Hamamatsu-shi (JP)

Correspondence Address: DRINKER BIDDLE & REATH (DC), 1500 K STREET, N.W., SUITE 1100, WASHINGTON, DC, 20005-1209, US

(73) Assignee: HAMAMATSU PHOTONICS K.K.

(21) Appl. No.: 11/783,991

(22) Filed: Apr. 13, 2007

Related U.S. Application Data
(60) Provisional application No. 60/791,891, filed on Apr. 14, 2006.

(51) Int. Cl. H01J 43/20; H01J 43/04

(52) U.S. Cl. 313/533; 313/532

(57) ABSTRACT

The present invention relates to a photomultiplier having a configuration for improving response time characteristics. The photomultiplier comprises at least a sealed container, a photocathode, and an electron multiplier section. The electron multiplier section has an upper unit and a lower unit. The upper unit includes a focusing electrode, a mesh electrode, and a first dynode, among a multiple stages of dynodes, being a dynode at which the photoelectrons from the photocathode arrive. The lower unit includes the subsequent dynodes while excluding the first dynode from the multiple stages of dynodes, and a pair of insulating supporting members that clampingly hold the subsequent dynodes. The mesh electrode is positioned in an inclined state with respect to a tube axis.

### CROSS-REFERENCE TO RELATED APPLICATION

This application claims priority to Provisional Application Ser. No. 60/781,891 filed on Apr. 14, 2006 by the same Applicant, which is hereby incorporated by reference in its entirety.

### BACKGROUND OF THE INVENTION

1. Field of the Invention

The present invention relates to a photomultiplier, in response to incidence of photoelectrons, capable of cascade-multiplying secondary electrons by successive emission of the secondary electrons in multiple stages.

2. Related Background Art

Development of TOF-PET (Time-of-Flight PET) as a next-generation PET (Positron Emission Tomography) device is being pursued actively in the field of nuclear medicine in recent years. Particularly, in a TOF-PET device, because two gamma rays, emitted from a radioactive isotope administered into a body, are measured simultaneously, a large number of photomultipliers of excellent, high-speed response properties are used as measuring devices that are disposed so as to surround a subject.

In particular, in order to realize high-speed response properties of higher stability, multichannel photomultipliers, in which a plurality of electron multiplier channels are prepared and electron multiplications are performed in parallel at the plurality of electron multiplier channels, are coming to be applied to next-generation PETs, such as that mentioned above, in an increasing number of cases. For example, a multichannel photomultiplier described in International Patent Publication No. WO2005/091332 has a configuration, in which a single faceplate is partitioned into a plurality of light incidence regions (each being a photocathode to which a single electron multiplier channel is allocated) and a plurality of electron multiplier sections (each comprising a dynode unit constituted by a plurality of stages of dynodes, and an anode), prepared as electron multiplier channels that are allocated to the plurality of light incidence regions, are sealed inside a single glass tube. A photomultiplier with the configuration, such that a plurality of photomultipliers are contained inside a single glass tube, is generally called a multichannel photomultiplier.

A multichannel photomultiplier thus has a configuration such that a function of a single-channel photomultiplier, with which photoelectrons emitted from a photocathode disposed on a faceplate are electron multiplied by a single electron multiplier section to obtain an anode output, is shared by the plurality of electron multiplier channels. For example, with a multichannel photomultiplier, with which four light incidence regions (photocathodes for electron multiplier channels) are arrayed in two dimensions, because for one electron multiplier channel, a photoelectron emission region (effective region of the corresponding photocathode) is made ¼ or less of the faceplate, electron transit time differences among the respective electron multiplier channels can be improved readily. Consequently, in comparison to the electron transit time differences within the entirety of a single channel photomultiplier, a significant improvement in electron transit time differences can be anticipated with the entirety of a multichannel photomultiplier.

### SUMMARY OF THE INVENTION

The inventors have studied conventional multichannel photomultipliers in detail, and as a result, have found problems as follows. Namely, in each of the conventional multichannel photomultipliers, because electron multiplications are performed by electron multiplier channels that are assigned in advance according to photoelectron emission positions of the photocathode, the positions of the respective electrodes are designed optimally to reduce electron transit time differences according to each electron multiplier channel. By such improvement of the electron transit time differences in each electron multiplier channel, improvements are made in the electron transit time differences of the multichannel photomultiplier as a whole and consequently, the high-speed response properties of the multichannel photomultiplier as a whole are improved.

However, in such multichannel photomultipliers, no improvements had been made in regard to the spread of the average electron transit time differences among the electron multiplier channels and further improvement of the high-speed response properties is required.

In order to overcome the above-mentioned problems, it is an object of the present invention to provide a photomultiplier that is significantly improved as a whole in such response time characteristics as TTS (Transit Time Spread) and CTTD (Cathode Transit Time Difference) by realizing a configuration for reducing emission-position-dependent photoelectron transit time differences of photoelectrons emitted from a photocathode.

Presently, developments of PET devices added with a function of TOF (Time-of-Flight) are performed. In photomultipliers used in such a PET device with TOF, CRT (Coincident Resolving Time) response characteristic also becomes important The conventional photomultipliers do not satisfy the request to CRT response characteristic in such a PET with FOP. Therefore, Thus, in the present invention, to make an improvement using an existing PET device as a base, the orbit-designing is performed to enable CRT measurement satisfying the request for PET device with FOP while keeping a bulb outer diameter the same as the present diameter. Specifically, the TTS, which is correlated to the CRT response characteristic, is improved and the orbit-designing is performed so that both the TTS within an entire faceplate and the TTS within each light incidence region are improved.

A photomultiplier according to the present invention comprises at least a sealed container, a photocathode, and an electron multiplier section. The sealed container has a hollow body extending along a predetermined tube axis. The photocathode is provided inside the sealed container and emits photoelectrons into the interior of the sealed container in response to incidence of light with a predetermined wavelength. The electron multiplier section is provided inside the sealed container and includes multiple stages of dynodes that cascade-multiply the photoelectrons emitted from the photocathode.

The electron multiplier section has an upper unit and a lower unit. The upper unit and the lower unit are positioned along the tube axis in the order of the upper unit and the lower unit as viewed from the photocathode.

The upper unit includes a focusing electrode, a mesh electrode, and a first dynode which, among the multiple stages of dynodes, is the dynode at which the photoelectrons from the photocathode arrive. The focusing electrode is arranged between the first dynode and the photocathode and is set to the same potential as the first dynode. The mesh electrode is arranged between the first dynode and the photocathode and is set to the same potential as the first dynode.

On the other hand, the lower unit includes the subsequent dynodes in which the first dynode is excluded from the multiple stages of dynodes, a pair of insulating supporting members that clampingly hold the subsequent dynodes.

In particular, in the photomultiplier according to the present invention, the mesh electrode is arranged in an inclined state with respect to the tube axis. By this structure, an electric field near the photocathode is made uniform and increased in electric field strength. By the electric field strength being increased, the electron transit time differences among the photoelectrons emitted from the photocathode are shortened and such response time characteristics as the TTS, CTTD, etc., are improved significantly.

Also, in the photomultiplier according to the present invention, the upper unit furthermore includes a partitioning electrode that partitions a space between the photocathode and the first dynode into two or more photoelectron transit spaces for electron multiplier channels in correspondence to photoelectron emission positions of the photocathode. This partitioning electrode is arranged between the photocathode and the first dynode and is set to a potential that is higher than that of the photocathode and yet lower than that of the focusing electrode.

In the photomultiplier according to the present invention, the pair of insulating supporting members of the lower unit has a support structure for mounting the upper unit. In this case, the support structure of the pair of insulating supporting members supports the partitioning electrode in a state of electrical isolation from the first dynode, the focusing electrode, and the mesh electrode.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a partially cutaway view showing a schematic configuration of an embodiment of a photomultiplier according to the present invention;

FIGS. 2A and 2B are diagrams showing an internal configuration of the photomultiplier shown in FIG. 1, as respectively viewed in directions along arrow A and arrow B in FIG. 1;

FIG. 3 is a plan view showing a faceplate of the photomultiplier shown in FIG. 1.

FIGS. 4A to 4C are diagrams showing cross sectional configurations, respectively taken on line I-I, line II-II, and line III-III shown in FIG. 3, of the photomultiplier shown in FIG. 1;

FIGS. 5A to 5C are diagrams showing cross sectional configurations, respectively taken on line IV-IV, line V-V, and line VI-VI shown in FIG. 3, of the photomultiplier shown in FIG. 1;

FIG. 6 is an assembly process diagram for explaining a configuration of a lower unit of an electron multiplier section in the photomultiplier according to the present invention;

FIG. 7 is a diagram for explaining a configuration of a pair of insulating supporting members that constitute portions of the lower unit shown in FIG. 6;

FIG. 8 is an assembly process diagram for explaining a configuration of an upper unit of the electron multiplier section in the photomultiplier according to the present invention;

FIG. 9 is a perspective view for explaining a final assembly process of the electron multiplier section in the photomultiplier according to the present invention;

FIG. 10 is a plan view for explaining a joint configuration between the upper unit and the lower unit;

FIGS. 11A to 11C show diagrams for explaining orbits of photoelectrons emitted from a photocathode as an explanation for a structural characteristic and effects of the photomultiplier according to the present invention;

FIGS. 12A to 12C show diagrams for explaining orbits of photoelectrons in a photomultiplier according to a first comparative example; and

FIGS. 13A to 13C show diagrams for explaining orbits of photoelectrons in a photomultiplier according to a second comparative example.

### DETAILED DESCRIPTION OF THE PREFERRED EMBODIMENTS

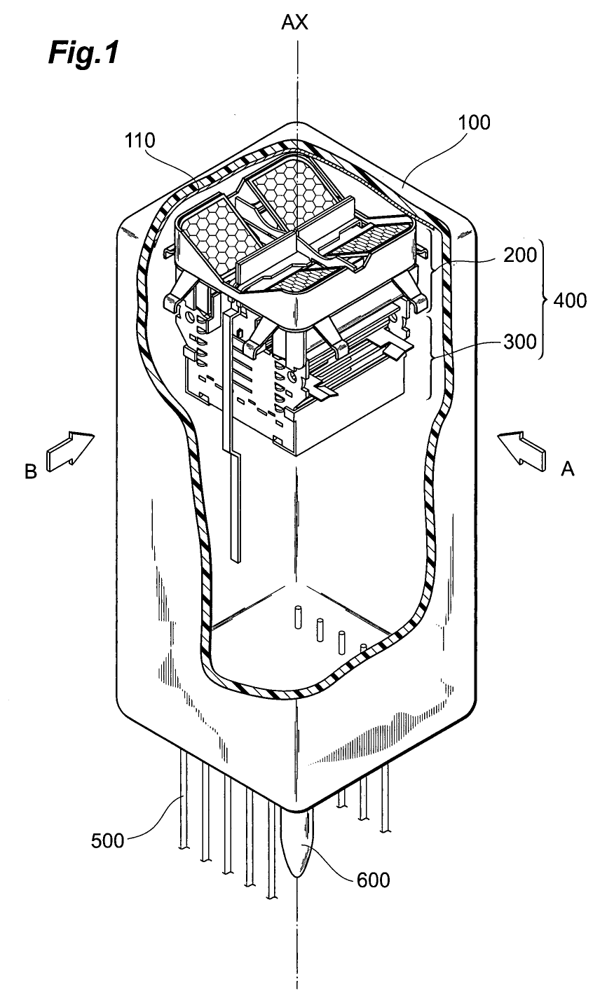

In the following, embodiments of a photomultiplier according to the present invention will be explained in detail with reference to FIGS. 1, 2A, 2B, 3, 4A-5C, 6-10, and 11A-13C. In the explanation of the drawings, constituents identical to each other will be referred to with numerals identical to each other without repeating their overlapping descriptions.

FIG. 1 is a partially cutaway view showing a schematic configuration of an embodiment of a photomultiplier according to the present invention.

As shown in FIG. 1, the photomultiplier according to the present invention comprises a sealed container 100, with a pipe 600, which is used to depressurize the interior to a predetermined degree of vacuum (and the interior of which is filled after vacuum drawing), provided at a bottom portion, and comprises a photocathode 110 and an electron multiplier section 400 which are provided inside the sealed container 100.

The sealed container 100 is constituted by a cylindrical bulb, having a faceplate, on an inner side of which is formed the photocathode 110, and a stem (bottom portion of the sealed container 100), which supports a plurality of lead pins 500 that penetrate through the stem. The installation position of the electron multiplier section 400 along a tube axis AX direction inside the sealed container 100 is defined by the lead pins 500 extend into the sealed container 100 from the stem. The electron multiplier section 400 has a double structure constituted by an upper unit 200 and a lower unit 300.

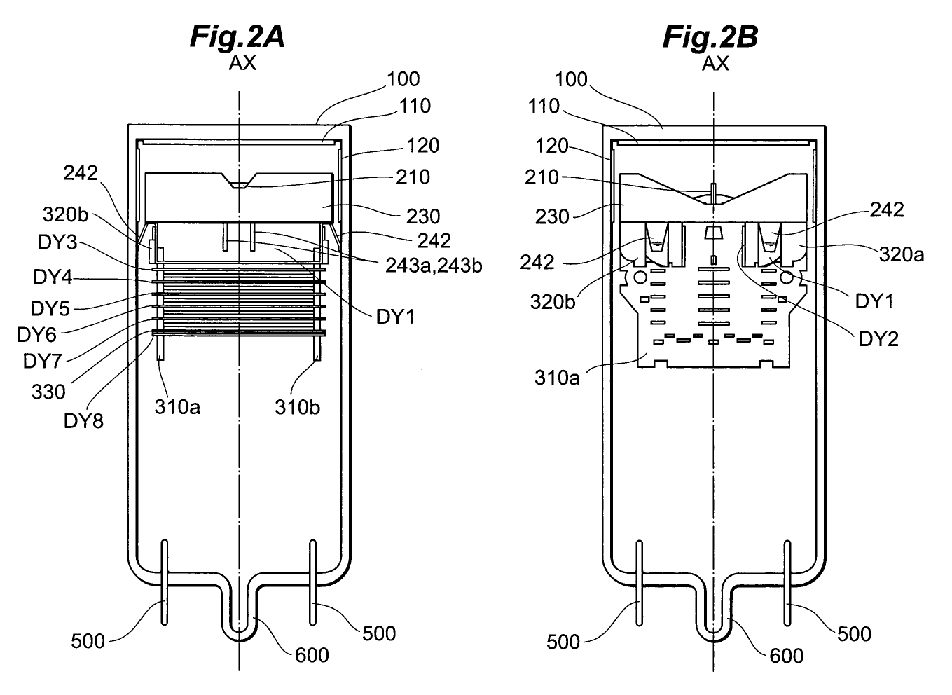

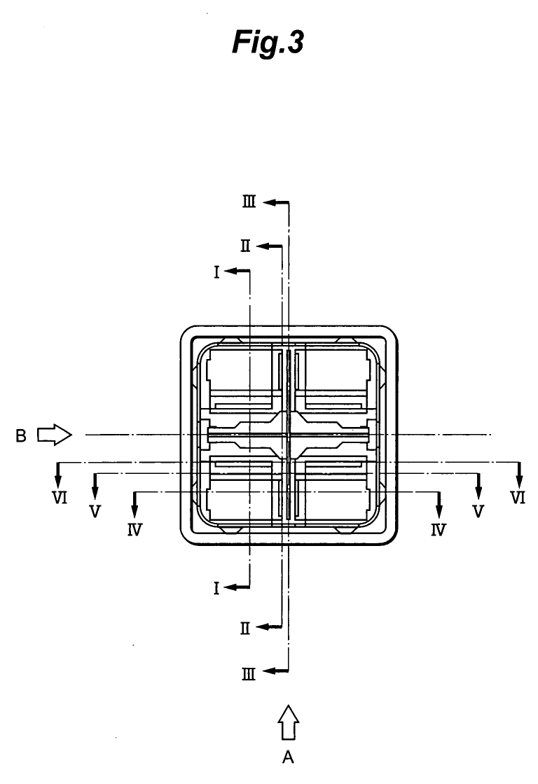

FIG. 2A is a diagram showing an inner configuration of the photomultiplier shown in FIG. 1 as viewed in the direction along arrow A in FIG. 1, and FIG. 2B is a diagram showing an inner configuration of the photomultiplier shown in FIG. 1 as viewed in the direction along arrow B in FIG. 1. FIG. 3 is a plan view showing the faceplate of the photomultiplier shown in FIG. 1. As can be seen from FIG. 3, the description that follows shall concern a multichannel photomultiplier having four electron multiplier channels (hereinafter referred to simply as “channels”) CH1 to CH4 as an embodiment of a photomultiplier according to the present invention.

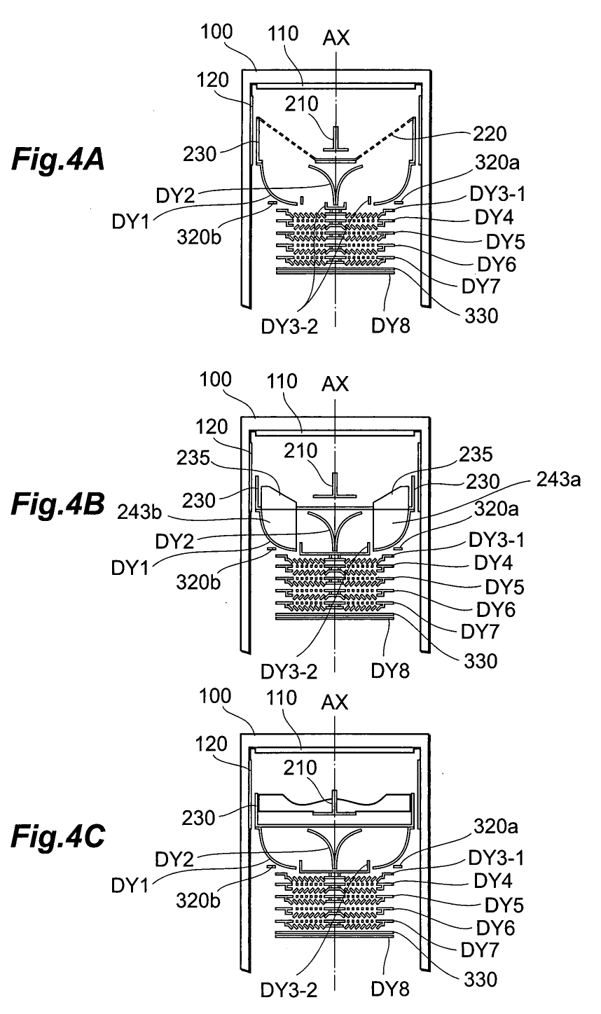

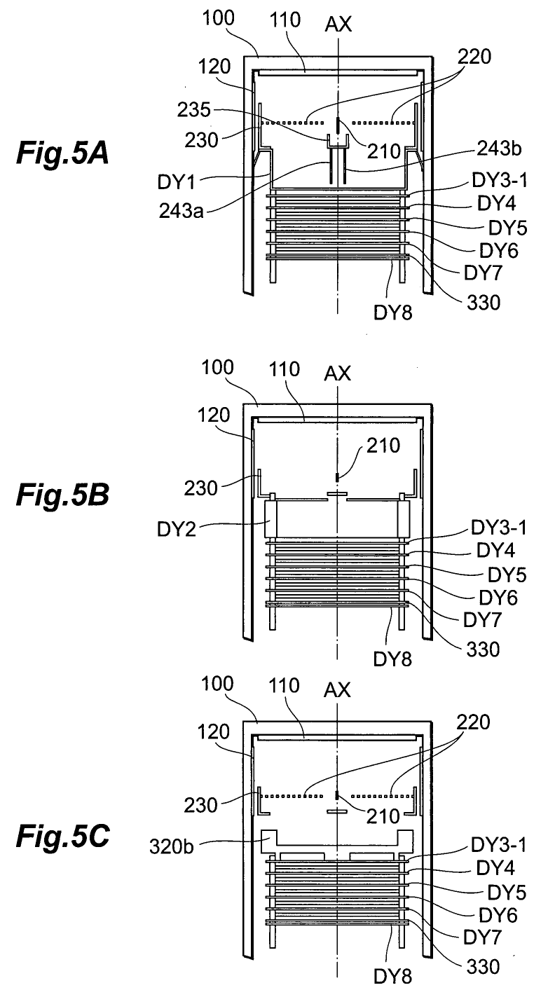

In particular, FIG. 4A is a diagram showing a cross sectional configuration, taken on line I-I shown in FIG. 3, of the photomultiplier shown in FIG. 1, FIG. 4B is a diagram showing a cross sectional configuration, taken on line II-II shown in FIG. 3, of the photomultiplier shown in FIG. 1, and FIG. 4C is a diagram showing a cross sectional configuration, taken on line III-III shown in FIG. 3, of the photomultiplier shown in FIG. 1. Also, FIG. 5A is a diagram showing a cross sectional configuration, taken on line IV-IV shown in FIG. 3, of the photomultiplier shown in FIG. 1, FIG. 5B is a diagram showing a cross sectional configuration, taken on line V-V shown in FIG. 3, of the photomultiplier shown in FIG. 1, and FIG. 5C is a diagram showing a cross sectional configuration, taken on line VI-VI shown in FIG. 3, of the photomultiplier shown in FIG. 1.

As shown in FIGS. 2A-2B, 3, 4A-4C, and 5A-5C, in the photomultiplier according to the present invention, the photocathode 110, which emits photoelectrons into the interior of the sealed container 100 in response to light arriving through the faceplate, and the electron multiplier section 400, which cascade-multiplies the photoelectrons emitted from the photocathode 110, are provided inside the sealed container 100. An aluminum electrode 120, for supplying a predetermined potential to the photocathode 110, is formed on an inner wall of the sealed container 100.

The electron multiplier section 400 is constituted by the upper unit 200 and the lower unit 300. The upper unit 200 is constituted by a pair of first dynodes DY1 (hereinafter referred to simply as the “first dynodes DY1”), which are arranged so as to sandwich the tube axis AX, a spring electrode 240, a focusing electrode 230, a mesh electrode 220, and a partitioning electrode 210. On the other hand, in the lower unit 300, subsequent dynodes DY2, DY3-1, and DY4 to DY8 and a mesh type anode 330 are arranged in that order from the faceplate toward the stem, and are integrally clamped by a pair of insulating supporting members 310a, 310b. The subsequent dynodes include the pair of second dynodes DY2 (hereinafter referred to simply as the “second dynodes DY2”), which are arranged so as to sandwich the tube axis AX in respective correspondence to the pair of first dynodes, and the third to eighth dynodes DY3-1 and DY4 to DY8, which have plate-like shapes. In each of the third to seventh dynodes DY3-1 and DY4 to DY7, electron multiplier holes for the four electron multiplier channels are formed along the same plane. The eighth dynode DY8 is a plate-shaped, inverting dynode. The mesh type anode 330 is positioned between the seventh dynode DY7 and the inverting dynode DY8. Here, the pair of first dynodes DY1 are arranged to be included not in the lower unit 300 but in the upper unit 200 to enable the length of the first dynodes in a longitudinal direction, that is, the sizes of the effective regions of the assigned channels to be set arbitrarily without being restricted by the interval between the pair of insulating supporting members 310a, 310b that constitute portions of the lower unit 300.

A control dynode DY3-2, for modifying the orbits of secondary electrons propagating from the first dynode DY1 to the second dynode DY2, is arranged between the second dynode DY2 and the third dynode DY3-1. Each of the first to seventh dynodes DY1, DY2, DY3-1, DY3-2, and DY4 to DY7 and the inverting dynode DY8 has an inverting-type secondary electron emitting surface formed thereon that receives photoelectrons or secondary electrons and newly emits secondary electrons.

In the upper unit 200, the first channel CH1 and the second channel CH2 are assigned to one of the pair of first dynodes DY1, and the third channel CH3 and the fourth channel CH4 are assigned to the other first dynode DY1. The first dynodes DY1 are welded to the focusing electrode 230, having side walls 230a that extend toward the photocathode 110, and the spring electrode 240, having a plurality of spring tabs 242 that are respectively put in contact with the inner wall of the sealed container 100 to stabilize the installation position of the electron multiplier section 400 with respect to the sealed container 100, is arranged between the first dynodes DY1 and the focusing electrode 230. The focusing electrode 230 has the mesh electrode 220 arranged at a position that opposes the photocathode 110. The mesh electrode 220 is provided with a plurality of channel meshes that are respectively assigned to the channels, and these channel meshes are provided in an inclined state with respect to the tube axis AX of the sealed container 100. The mesh electrode 220 is set to the same potential as the focusing electrode 230. The partitioning electrode 210, for partitioning electron transit spaces of the channels CH1 to CH4, is provided above the mesh electrode 220. The partitioning electrode 210 is directly supported by the pair of insulating supporting members 310a, 310b while being separated from the photocathode 100 and being set to a potential between the potential of the photocathode 100 and that of the focusing electrode 230.

On the other hand, in similar to the first dynodes DY1, the first channel CH1 and the second channel CH2 are assigned to one of the pair of second dynodes DY2 in the lower unit 300, and the third channel CH3 and the fourth channel CH4 are assigned to the other second dynode DY2. Each of the third dynode DY3-1 to the seventh dynode DY7 is a metal plate having electron multiplier holes for the first to fourth channels CH1 to CH4 provided onto the same plane. The inverting dynode DY8 is prepared for guiding the orbits of the secondary electrons that have passed through the anode 330 back to the mesh type anode 330.

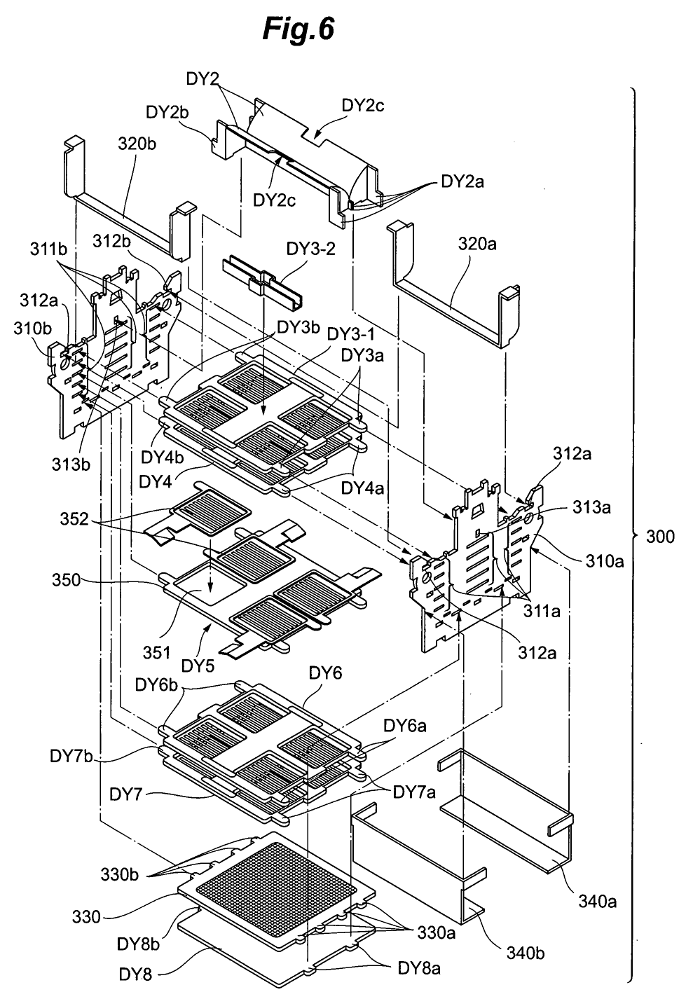

The configuration of the electron multiplier section 400 in the photomultiplier according to the present invention shall now be explained in detail with reference to FIGS. 6 to 10.

First, FIG. 6 is an assembly process diagram for explaining the configuration of the lower unit 300 of the electron multiplier section 400 in the photomultiplier according to the present invention. In FIG. 6, the lower unit 300 has the pair of insulating supporting members (first insulating supporting member 310a and second insulating supporting member 310b) that clampingly hold the respective electrode members. Specifically, the first and second insulating supporting members 310a, 310b integrally clamp the pair of second dynodes DY2, to each of which are assigned adjacent channels, the plate-shaped third dynode DY3-1 to the seventh dynode DY7, with each of which the channels are respectively assigned onto the same plane, the mesh type anode 330, and the plate-shaped inverting dynode DY8. The control dynode DY3-2 for modifying the orbits of secondary electrons is arranged between the second dynode DY2 and the third dynode DY3-1. Holding electrodes 320a, 320b, for stable mounting of the first dynodes DY1, which constitute portions of the upper unit 200, on the first and second insulating supporting members 310a, 310b, are fixed to upper portions of the first and second insulating supporting members 310a, 310b. Meanwhile, metal clips 340a, 340b, for maintaining the interval between the first and second insulating supporting members 310a, 310b and maintaining the clamped states of the respective electrode members, are mounted to lower portions of the first and second insulating supporting members 310a, 310b.

The second dynodes DY2 have notches DY2c at positions that partition adjacent channels (channels CH1, CH2 or channels CH3, CH4), and fixing tabs DY2a, DY2b are provided at opposite ends of the second dynode channels DY2 to enable the second dynode channels DY2 to be clamped by the first and second insulating supporting members 310a, 310b. Similarly, electron multiplier holes for the first to fourth channels CH1 to CH4 are provided onto the plate that constitutes the third dynode DY3-1, and fixing tabs DY3a, DY3b are provided at opposite ends of the plate that constitutes the third dynode DY3-1. The fourth dynode DY4 is also constituted by a plate, and fixing tabs DY4a, DY4b are provided at opposite ends of this plate. The fifth dynode DY5 has fixing tabs DY5a, DY5b provided at opposite ends of the plate that constitutes the fifth dynode DY5, the sixth dynode DY6 has fixing tabs DY6a, DY6b provided at opposite ends of the plate that constitutes the sixth dynode DY6, and the seventh dynode DY7 has fixing tabs DY7a, DY7b provided at opposite ends of the plate that constitutes the seventh dynode DY7. The anode 330 is a mesh type plate, and fixing tabs 330a, 330b are provided at opposite ends of this anode plate as well. The inverting dynode DY8 has fixing tabs DY8a, DY8b provided at opposite ends of the plate that constitutes the inverting dynode DY8.

The control dynode DY3-2 is welded to the third dynode DY3-1 while being positioned so as to partition the channels CH1, CH2 from the channels CH3, CH4. The fifth dynode DY5 has a ceramic plate 350, provided with channel openings 351 that are assigned to the channels CH1 to CH4, and in each of these channel openings 351 is disposed a control electrode 352 with electron multiplier holes. The control electrodes 352 are respectively insulated from each other and because the potential of these can be set independent of each other, by adjustment of the potentials of the control electrodes 352 according to the respective channels, the multiplication factors of the electron multiplier channels are adjusted independent of each other.

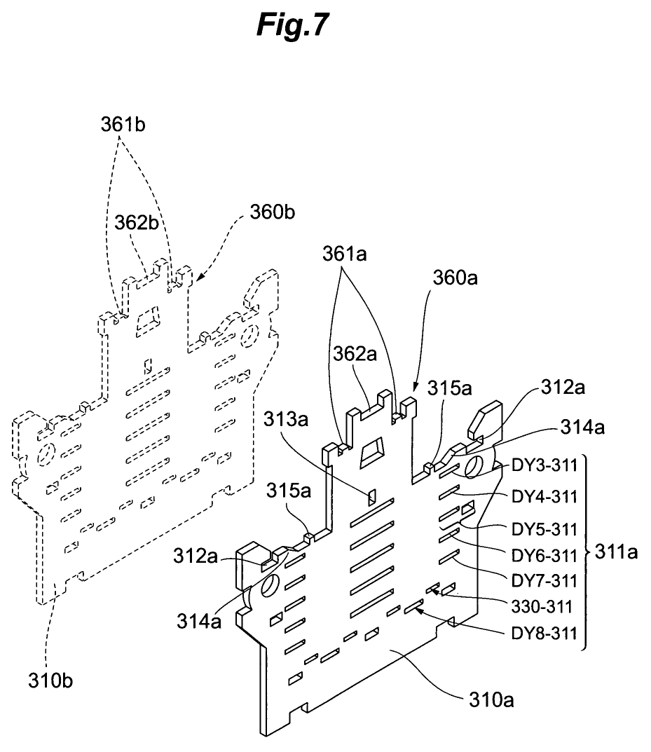

FIG. 7 is a diagram for explaining the configuration of the pair of insulating supporting members 310a, 310b that constitutes parts of the lower unit 300 shown in FIG. 6. Because the first insulating supporting member 310a and the second insulating supporting member 310b are of identical shape, a description shall be provided only for the first insulating supporting member 310a below, and a description of the second insulating supporting member 310b shall be omitted. Respective parts of the second insulating supporting member 310b are indicated by symbols, with which the suffix “a” of the symbols indicating respective portions of the first insulating supporting member 310a is changed to the suffix “b.”

The first insulating supporting member 310a is constituted by a main body which supports the dynodes and other electrode members that constitute the lower unit 300, and a protruding portion 360a which extends from the main body to the photocathode 110 (the corresponding part of the second insulating supporting member 310b is indicated by 360b).

In the main body of the first insulating supporting member 310a are provided with fixing slits DY3-311, DY4-311, DY5-311, DY6-311, DY7-311, 330-331, and DY8-311, into which the fixing tabs DY3a of the third dynode DY3-1, the fixing tabs DY4a of the fourth dynode DY4, the fixing tabs DY5a of the fifth dynode DY5, the fixing tabs DY6a of the sixth dynode DY6, the fixing tabs DY7a of the seventh dynode DY7, the fixing tabs 330a of the anode 330, and the fixing tabs DY8a of the inverting dynode DY8 are inserted to hold these electrode members integrally along with the second insulating supporting member 310b (fixing slits of the same form are formed in the main body of the second insulating supporting member 310b as well).

The configurations for mounting the first dynodes DY1 are provided at an upper end of the first insulating supporting member 310a. Specifically, the upper end of the first insulating supporting member 310a, is provided with pedestal portions 314a on which the first dynodes DY1 are directly set, stopper portions 315a for preventing the deviation of the first dynodes DY1 in the direction orthogonal to the longitudinal direction of the first dynodes DY1, and fixing slits 312a in which is mounted the holding electrodes 320a, 320b that prevents the deviation of the first dynodes DY1 in the longitudinal direction of the first dynodes DY1 (an upper end of the second insulating supporting member 310b is also provided with the same structures).

The protruding portion 360a of the first insulating supporting member 310a is provided with a fixing structure 313a in which fixing tabs DY2a of the second dynodes is mounted to hold the second dynodes DY2. The protruding portion 360a is also provided with pedestal portions 361a on which the focusing electrode 230 is directly set, and a pedestal portion 362a on which the partitioning electrode 210 is directly set (the protruding portion 360b of the second insulating supporting member 310b is also provided with the same structures).

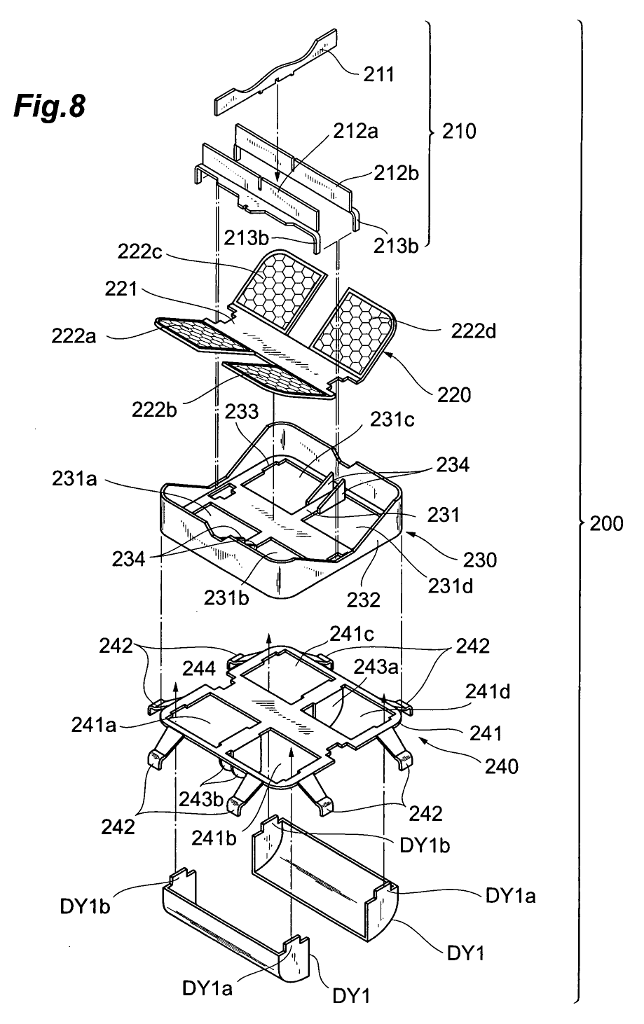

FIG. 8 is an assembly process diagram for explaining the configuration of the upper unit 200 of the electron multiplier section 400 in the photomultiplier according to the present invention.

The upper unit 200 is constituted by the partitioning electrode 210 for partitioning the electron transit spaces of the channels CH1 to CH4, the mesh electrode 220, the focusing electrode 230, the spring electrode 240, and the first dynode DY1.

The partitioning electrode 210 is constituted by a pair of first electrodes 212a, 212b that partition the channels CH1, CH2 from the channels CH3, CH4, and a second electrode 211 that partitions the channels CH1, CH3 from the channels CH2, CH4. At opposite ends of the first electrodes 212a, 212b are provided connecting tabs 213a, 213b that define an installation position of the partitioning electrode 210 with respect to the pair of insulating supporting members 310a, 310b that constitute parts of the lower unit 300 and are used for applying a predetermined voltage to the partitioning electrode 210.

The mesh electrode 220 has a main body 221 which is welded to the focusing electrode 230, and channel meshes 222a to 222d which are formed integral to the main body 221 and are positioned in inclined states with respect to the tube axis AX.

The focusing electrode 230 has a base plate 231, provided with channel openings 231a to 231d corresponding to the respective electron multiplier channels, and a side wall 232 that surrounds the base plate 231. The channel openings 231a to 231d in the focusing electrode 230 are provided with notches 233 in which the fixing tabs DY1a, DY1b of the first dynodes DY1 are set. By the fixing tabs DY1a, DY1b of the first dynodes DY1 being welded in the notches 233, the first dynodes DY1 are fixed to the focusing electrode 230 via the spring electrode 240. The focusing electrode 230 and the first dynodes DY1 are thus set to the same potential. The base plate 231 of the focusing electrode 230 is furthermore provided with partition plates 234 that extend toward the photocathode 110, and these partition plates 234 partition channels CH1, CH2 from each other and partition channels CH3, CH4 from each other.

A base plate 241 of the spring electrode 240 is also provided with channel openings 241a to 241d in correspondence to the respective electron multiplier channels, and the spring electrode 240 is welded to a lower face of the focusing electrode 230. A plurality of spring tabs 242 are provided on an outer periphery of the base plate of the spring electrode 240, and by the plurality of spring tabs 242 contacting the inner wall of the sealed container 100, the installation position of the entirety of the electron multiplier section 400 inside the sealed container 100 (the position in directions orthogonal to the tube axis AX) is defined. As with the focusing electrode 230, each of the channel openings 241a to 241d, formed in the base plate 241 of the spring electrode 240, is provided with a notch 244 for holding the fixing tab DY1a or DY1b of the first dynodes DY1. The spring electrode 240 is also provided with partitioning plates 243a, 243b that extend toward the first dynodes DY1 positioned below, and these partitioning plates 243a, 243b partition the effective regions of mutually adjacent channels assigned to the first dynodes DY1.

One of the pair of first dynodes DY1 has a secondary electron emitting surface that is assigned to the channels CH1, CH2 and the fixing tabs DY1a, DY1b are provided at opposite ends of this surface. The other first dynode DY1 has a secondary electron emitting surface that is assigned to the channels CH3, CH4 and the fixing tabs DY1a, DY1b are provided at opposite ends of this surface. These fixing tabs DY1a, DY1b are welded, via the notches 244 provided in the respective channel openings 241a to 241d of the spring electrode 240, to the notches 233 provided in the respective channel openings 231a to 231d of the focusing electrode 230. The pair of first dynodes DY1 are thus fixed to the lower portion of the focusing electrode 230.

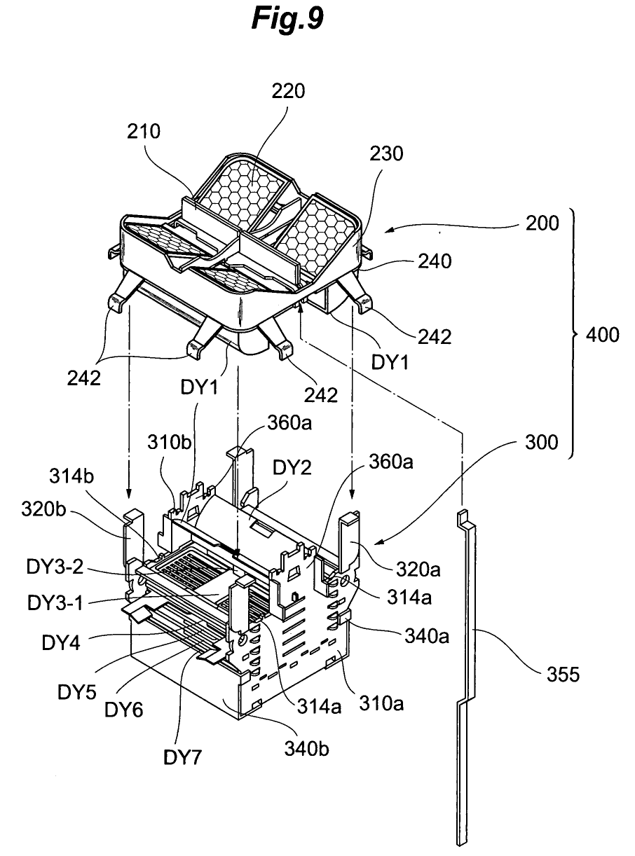

The electron multiplier section 400 is constituted by the upper unit 200 being mounted onto the lower unit 300 that is arranged as described above. FIG. 9 is a perspective view for explaining a final assembly process of the electron multiplier section 400 in the photomultiplier according to the present invention. As shown in FIG. 9, at the time that the upper unit 200 is mounted onto the lower unit 300, the first dynodes DY1 are set on the pedestal portions 314a, 314b provided on the pair of insulating supporting members 310a, 310b, respectively, with the focusing electrode 230 being supported by the protruding portions 360a, 360b of the pair of insulating supporting members 310a, 310b. In the upper unit 200 thus being mounted on the lower unit 300, the first dynodes DY1 are respectively welded to the holding electrodes 320a, 320b mounted on the pair of insulating supporting members 310a, 310b. A metal lead 355, for electrical connection with a lead pin 500 extending from the stem of the sealed container 100, is welded to the connecting tabs 212a, 212b provided on the vertical electrodes 213a, 213b that constitute parts of the partitioning electrode 210, set on the protruding portions 360a, 360b of the pair of insulating supporting members 310a and 310b in a state of being separated from the focusing electrode 230.

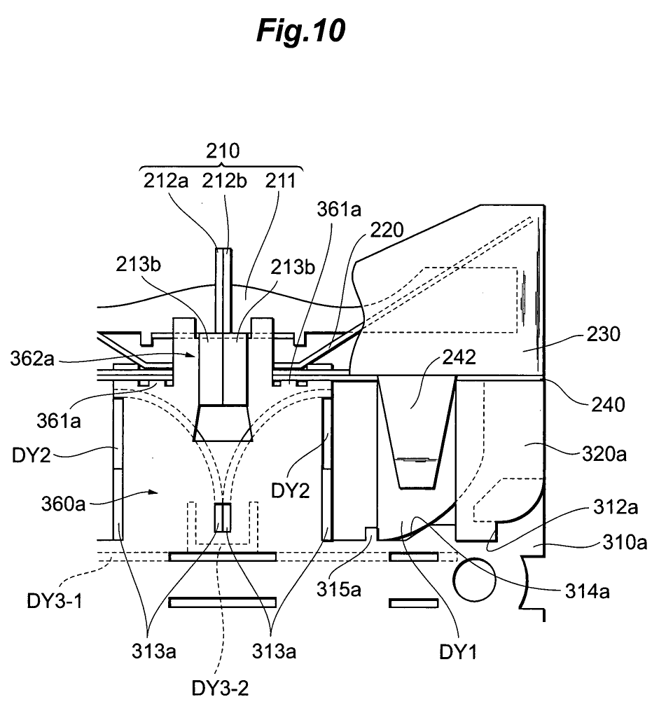

FIG. 10 is a plan view for explaining the joint configuration between the upper unit 200 and the lower unit 300. In FIG. 10, just the configuration at the first insulating supporting member 310a side is shown, and the configuration at the second insulating supporting member 310b side, which is identical, is omitted.

As shown in FIG. 10, the first dynodes DY1 which are positioned by the stopper portions 315a while being set on the pedestal portions 314a of the first insulating supporting member 310a. In this state, side faces of the first dynodes DY1 are welded to the holding electrode 320a whose parts are sandwiched by the fixing slits 312a.

On the other hand, the second dynodes DY2 are held by the fixing structure 313a of the protruding portion 360a of the first insulating supporting member 310a. The focusing electrode 230, whose lower surface is welded the base plate 241 of the spring electrode 240 and whose upper surface is welded the main body 221 of the mesh electrode 220, is set on the pedestal portions 361a of the protruding portion 360a. Furthermore, the vertical electrodes 212a, 212b that constitute portions of the partitioning electrode 210 are mounted onto the pedestal portion 362a of the protruding portion 360a. In this state, the positional deviation of the partitioning electrode 210 with respect to the first insulating supporting member 310a is prevented by the connecting tabs 213a, 213b provided at the opposite ends of the vertical electrodes 212a, 212b.

The structural characteristic of the photomultiplier according to the present invention and the effects thereof shall now be explained in detail. In explanation of the structural characteristic, because the configurations of other parts are the same as the above-described configurations shown in FIGS. 1 to 10, overlapping description shall be omitted.

The structural characteristic is characterized by: (1) the disposition of the V-shaped mesh electrode 220 on the focusing electrode 230 (set to the same potential as the first dynodes DY1), onto which the first dynodes DY1 are fixed, (2) the disposition of the partitioning electrode, set to a potential between the potential of the photocathode 110 and the potential of the focusing electrode 230 (potential of the first dynodes DY1), between the photocathode 110 and the focusing electrode 230 so as to partition adjacent channels, or (3) the combination of these arrangements.

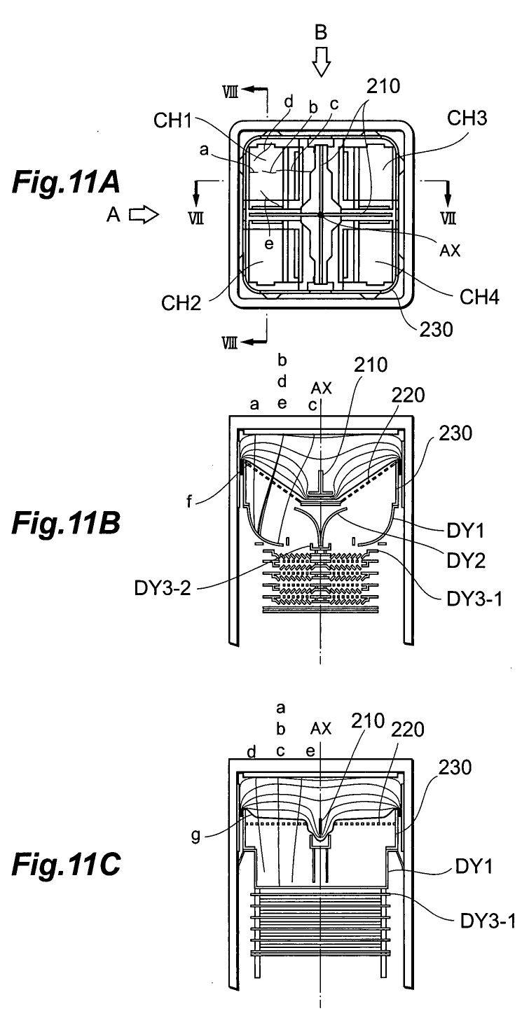

FIGS. 11A to 11C show diagrams for explaining orbits of photoelectrons emitted from a photocathode as an explanation for the first structural characteristic and effects of the photomultiplier according to the present invention. Specifically, FIG. 11A shows a plan view of the faceplate of the photomultiplier according to the present invention, FIG. 11B shows a cross sectional view of the photomultiplier according to the present invention taken on line VII-VII shown in FIG. 11A, and FIG. 11C shows a cross sectional view of the photomultiplier according to the present invention taken on line VIII-VIII shown in FIG. 11A. In FIGS. 11A to 11C, lines a to e respectively indicate an orbit of photoelectron propagating from the photocathode 110 to the first dynode DY1, and lines f and g respectively indicate an equipotential line.

In the photomultiplier, having such a configuration, according to the present invention, the partitioning electrode 210 that partitions adjacent channels is a floating electrode arranged between the photocathode 110 and the focusing electrode 230 while being separated from both the photocathode 110 and the focusing electrode 230, and the potential thereof is set to a potential between the potential of the photocathode 110 and the potential of the focusing electrode 230, namely the same potential of the first dynodes DY1. The channel meshes 222a to 222d of the mesh electrode 220 are arranged in an inclined state with respect to the tube axis AX in order to cover the channel openings 231a to 231d of the focusing electrode 230, and therefore the side walls of the focusing electrode 230 are made high along the tube axis AX.

Due to the first structural characteristic, the electric field near the photocathode 110 is made uniform and the electric field strength thereof is increased. Similarly, the qeuipotential lines near the channel meshes 222a to 22d (line f in FIG. 11A and line g in FIG. 11C) are also made uniform and the electric field strength thereof is increased. Due to the uniformly increasing of the electric field strength near the photocathode 110 and near the channel meshes 222a to 222d, the electron transit time differences among the photoelectrons emitted from the photocathode 110 (and propagating along any orbits a to e according to differences in emission position) are shortened and such response time characteristics as the TTS, CTTD, etc., are improved significantly.

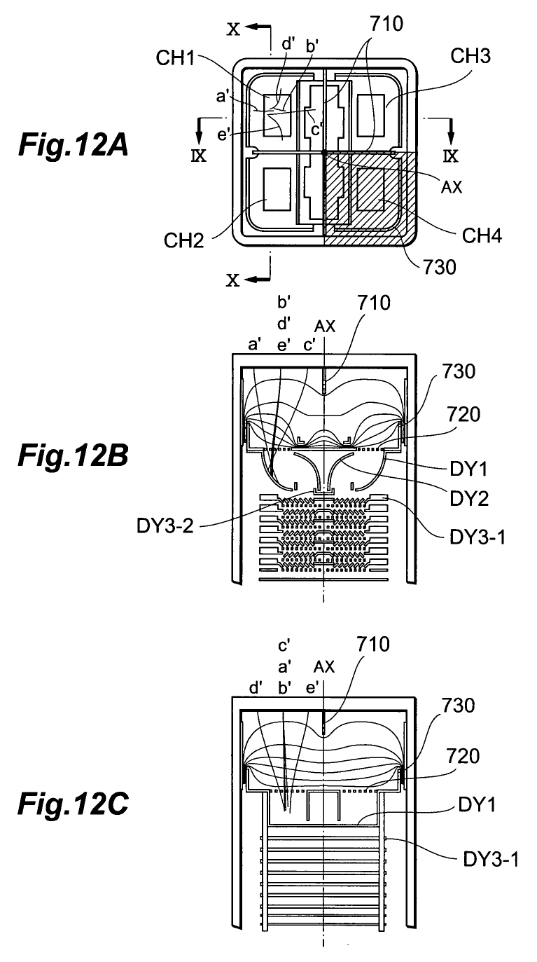

FIGS. 12A to 12C show diagrams for explaining photoelectron orbits in a photomultiplier according to a first comparative example. Specifically, FIG. 12A shows a plan view of a face plate of the photomultiplier according to the first comparative example, FIG. 12B shows a sectional view of the photomultiplier according to the first comparative example taken on line IX-IX shown in FIG. 12A, and FIG. 12C shows a sectional view of the photomultiplier according to the first comparative example taken on line X-X shown in FIG. 12A. In FIGS. 12A to 12C, lines a′ to e′ respectively indicate an orbit of photoelectron propagating from the photocathode 110 to the first dynode DY1.

In the photomultiplier according to the first comparative example shown in FIGS. 12A to 12C, a partitioning electrode 710 that partitions adjacent channels is provided on a photocathode so as to be set to the same potential as the photocathode. That is, in the first comparative example, the respective light incidence regions of adjacent channels are partitioned by the partitioning electrode 710 that is set to the photocathode potential. The channel meshes 720a to 720d of the mesh electrode 720 are arranged so as to cover the channel openings of the focusing electrode 730. Therefore, the side walls of the focusing electrode 730 is made low.

By this structure, the electric field near the photocathode is not uniform, and because the electric field strength is weak, large time differences occur among the electron transits of the photoelectrons in accordance with the emission positions on the photocathode. For example, as compared between orbits a′ to e′, the respective electron transit times of the orbits a′, c′, d′, and e′ are slow as compared with that of the orbit b′. Thus, in the photomultiplier according to the first comparative example that comprises the partitioning electrode 710 (set to the same potential as the photocathode) that partitions adjacent channels on the photocathode, such response time characteristics as the TTS, CTTD, etc., are poor.

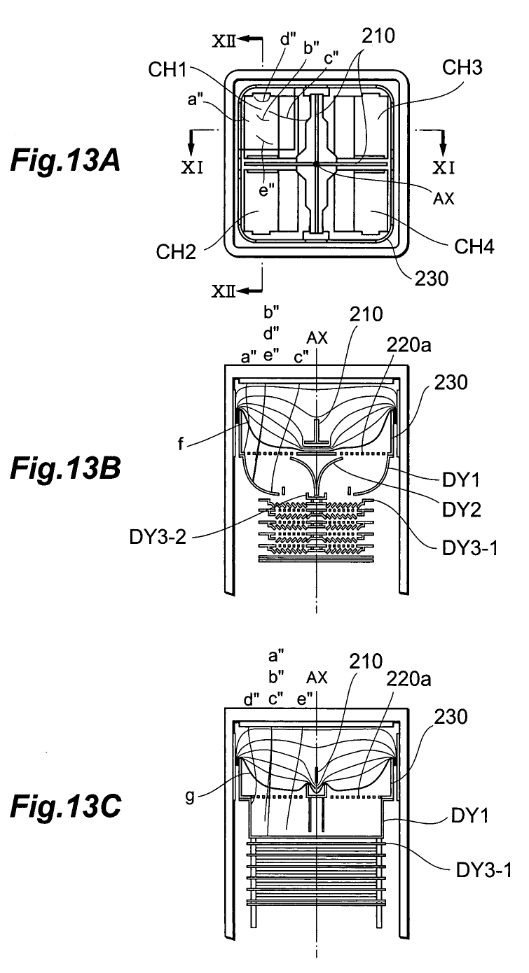

FIGS. 13A to 13C show diagrams for explaining photoelectron orbits in a photomultiplier according to a second comparative example. Specifically, FIG. 13A shows a plan view of a faceplate of the photomultiplier according to the second comparative example, FIG. 13B shows a cross sectional view showing the photomultiplier according to the second comparative example taken on line XI-XI shown in FIG. 13A, and FIG. 13C shows a cross sectional view showing the photomultiplier according to the second comparative example taken on line XII-XII shown in FIG. 13A. In FIGS. 13A to 13C, lines a″ to e″ respectively indicate an orbit of photoelectron propagating from the photocathode 110 to the first dynode DY1, and lines f″ and g″ respectively indicate an equipotential line.

In the photomultiplier according to the second comparative example shown in FIGS. 13A to 13C, the channel meshes 220a of the mesh electrode is positioned so as to cover the channel openings 231a to 231d of the focusing electrode 230 (so as to be orthogonal to the tube axis AX). In this case, as shown by equipotential lines f″ and g″, since a diverging lens is formed in part, parts of the photoelectrons, that pass through the channel openings 231a to 231d of the focusing electrode 230 propagate along orbits a″ and d″ and collide with the focusing electrode 230 itself or with the side walls of the first dynodes DY1.

The present invention cannot be limited to the above embodiments, and can be realized by the following embodiments.

Namely, in the photomultiplier according to the present invention, as shown in FIG. 6, a second dynode DY2, which is included in the subsequent dynodes held by the pair of insulating supporting members 310a, 310b of the lower unit 300, is the dynode at which secondary electrons, emitted from the first dynode DY1 in response to the incidence of the photoelectrons, arrive, has one or more notches DY2c for partitioning effective regions for two or more electron multiplier channels that are assigned along a longitudinal direction of the second dynode DY2. In this case, because the notches DY2c are arranged at positions that partition adjacent electron multiplier channels in the second dynode DY2, a sufficient distance is secured between the second dynode DY2 and the focusing electrode 230. Thus, in such a structure, a sufficient discharge withstand voltage can be secured without having to modify electron orbits.

In the photomultiplier according to the present invention, as shown in FIGS. 2A and 5A, the first dynode DY1 included in the upper unit 200 is mounted on the pair of insulating supporting members 310a, 310b in a state in which opposite ends in a longitudinal direction of the first dynode DY1 contact the pair of insulating supporting members 310a, 310b. The length in the longitudinal direction of the first dynode DY1 is made greater than the interval between the pair of insulating supporting members 310a, 310b.

In this structure, the length in the longitudinal direction of the first dynode DY1 and thus the sizes of the effective regions of the assigned electron multiplier channels can be set arbitrarily without being restricted by the pair of insulating supporting members 310a, 310b that constitute portions of the lower unit 300. The length in the longitudinal direction of the first dynode DY1 is set to be longer than the interval of the pair of insulating supporting members 310a, 310b, and therefore, within each electron multiplier channel, the photoelectrons emitted from the light incidence region to the first dynode DY1 arrive at the first dynode reliably.

Furthermore, in the photomultiplier according to the present invention, as shown in FIG. 8, the upper unit 200 has partitioning plates 234, 243a, 243b for partitioning the effective regions for two or more electron multiplier channels that are aligned along the longitudinal direction of the first dynode DY1. Normally, crosstalk occurs between adjacent electron multiplier channels. The crosstalk that occurs between adjacent electron multiplier channels significantly increase the electron transit time differences in each channel. In contrast, in accordance with this structure, due to the presence of the partitioning plates 234, 243a, 243b, the electrons multiplied in one electron multiplier channel are prevented from reaching the effective region of another electron multiplier channel that is adjacent.

The partitioning plates may include parts 234 (fins) of the focusing electrode 230. In this case, the partitions may just be fins that extend from the photocathode 110 to the lower unit 300 or may include other fins that extend from the lower unit 300 to the photocathode 110. When the upper unit has a spring electrode, with two or more spring tabs that respectively contact an inner wall of the hollow body, for installing the entire electron multiplier section at a predetermined position inside the sealed container, parts 243a, 243b (fins) of the spring electrode 240 that extend from the photocathode 110 to the lower unit 300 may be made to function as the partitioning plates.

As described above, in accordance with the photomultiplier according to the present invention, such response time characteristics, as TTS and CTTD, are improved significantly.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A photomultiplier comprising:
a sealed container having a hollow body which extends along a predetermined tube axis;
a photocathode, for emitting photoelectrons into the interior of said sealed container in response to incidence of light with a predetermined wavelength, provided inside said sealed container; and
an electron multiplier section provided inside said sealed container, said electron multiplier section including multiple stages of dynodes that cascade-multiply the photoelectrons emitted from said photocathode,
wherein the electron multiplier section has:
an upper unit including: a first dynode, among said multiple stages of dynodes, being a dynode at which the photoelectrons from said photocathode arrive; a focusing electrode which is provided between said first dynode and said photocathode while being set to the same potential as said first dynode; and a mesh electrode which is provided between said first dynode and said photocathode while being set to the same potential as said first dynode; and
a lower unit including: subsequent dynodes in which said first dynode is excluded from said multiple stages of dynodes; and a pair of insulating supporting members that clampingly hold the subsequent dynodes, and
wherein said mesh electrode is positioned in an inclined state with respect to the tube axis.

2. A photomultiplier according to claim 1, wherein said upper unit further includes a partitioning electrode that partitions a space between said photocathode and said first dynode into two or more photoelectron transit spaces for electron multiplier channels in correspondence to photoelectron emission positions of said photocathode, said partitioning electrode being provided between said photocathode and said first dynode while being set to a potential that is higher than that of said photocathode but yet lower than that of said focusing electrode.

3. A photomultiplier according to claim 1, wherein said pair of insulating supporting members of said lower unit has a holding structure for mounting said upper unit, and
wherein the support structure of said pair of insulating supporting members supports said partitioning electrode in a state of electrical isolation from said first dynode, said focusing electrode, and said mesh electrode.
